(19) United States
(12) Patent Application Publication
(10) Pub. No.: US 2011/0185829 A1
(43) Pub. Date: Aug. 4, 2011

(54) ROTATIONAL VIBRATION GYRO

(75) Inventors: Tetsuo Sugita, Kanagawa (JP); Mitsuru Koarai, Kanagawa (JP); Yuuichi Yamamura, Kanagawa (JP)

(73) Assignee: Pioneer Corporation, Kanagawa (JP)

(21) Appl. No.: 13/057,792

(22) PCT Filed: Aug. 6, 2008
(86) PCT No.: PCT/JP2008/002127

§ 371 Date: Apr. 6, 2011

(51) Int. Cl. G01C 19/08

(52) U.S. Cl. 74/5.7

(57) ABSTRACT

A rotational vibration type gyro 1 is provided by which a detection sensitivity influence of the other axis direction on detection sensitivity in a detection axis direction. The rotational vibration type gyro 1 has: a drive weight 4, drive electrodes 3, a detection weight 5 having a pair of X-axis divisional detection weights 5A, 5A and a pair of Y-axis divisional detection weights 5B, 5B, an anchor 6, a pair of X-axis weight support springs 7A, 7A and a pair of Y-axis weight support springs 7B, 7B, a pair of X-axis weight connection springs 8A, 8A and a pair of Y-axis weight connection springs 8B, 8B, and a pair of X-axis detection electrodes 9A, 9A and a pair of Y-axis detection electrodes 9B, 9B.

### TECHNICAL FIELD

The present invention relates to a rotational vibration gyro which is a rotational vibration type angular velocity sensor in a MEMS (micro electro mechanical system) sensor.

### BACKGROUND ART

There is a known rotational vibration type gyro in which drive electrodes are disposed inside a circular ring shaped mass portion (see Document 1). The rotational vibration type gyro includes a fixed portion (anchor) projecting from a substrate, a circular flat plate shaped mass portion (a drive weight and a detection weight), radial mass support portions (support springs) connecting the fixed portion and the mass portion, drive electrodes which rotationally vibrate the mass portion, and four detection electrodes facing to the mass portion. In a state that the mass portion is rotationally vibrated by applying a voltage to the drive electrodes and angular velocity in the X-axis direction is exerted (an angular velocity motion), Coriolis force is excited and the mass portion vibrates like a seesaw around the Y-axis. Electrostatic capacitance between the mass portion and the detection electrodes changes by the vibration and the angular velocity is detected based on the change.

### [Document 1] JP-A-2000-180177

### DISCLOSURE OF THE INVENTION

### Problems to be Solved

In such a known rotational vibration type gyro, for example, when the gyro receives the angular velocity around the X-axis, the mass portion vibrates like a seesaw around the Y-axis by the Coliolis force. Since the mass portion is formed in shape of a circular ring integrally, the electrostatic capacitance between the detection electrodes in the Y-axis direction and the mass portion changes by the vibration. Therefore, detection sensitivity in a detection axis direction suffers from detection sensitivity in the other axis direction. After all, there is a problem in which the detection sensitivity will be lowered and the angular velocity can not be detected accurately.

Accordingly, an object of the invention is to provide a rotational vibration type gyro which can eliminate an influence of the detection sensitivity in the other direction on detection sensitivity in a detection axis direction.

### Means to Solve the Problems

A rotational vibration type gyro of the present invention has: a drive weight in shape of a circular flat plate, a drive electrode that rotationally vibrates the drive weight around a Z-axis which passes through a center thereof, a detection weight that is disposed inside the drive weight and that has a pair of X-axis divisional detection weights in a flat plate shape vibrated with the drive weight by Coriolis force and a pair of Y-axis divisional detection weights in a flat plate shape vibrated independently from each of the X-axis divisional detection weights with the drive weight by the Coriolis force, an anchor that is projected inside the detection weight on a substrate and that supports the drive weight and the detection weight, a pair of X-axis weight support springs that are suspended between the anchor and each of the X-axis divisional detection weights and that function as hinge of each of the vibrating X-axis divisional detection weights, and a pair of Y-axis weight support springs that are suspended between the anchor and each of the Y-axis divisional detection weights and that function as hinge of each of the vibrating Y-axis divisional detection weights, a pair of X-axis weight connection springs that have an absorbing function for the rotational vibration and a transmitting function for the Coriolis force and that connect the drive weight and each of the X-axis divisional detection weights, and a pair of Y-axis weight connection springs that have an absorbing function for the rotational vibration and a transmitting function for the Coriolis force and that connect the drive weight and each of the Y-axis divisional detection weights, and a pair of X-axis detection electrodes that detect displacement of the vibrating pair of X-axis divisional detection weights and/or a pair of Y-axis detection electrodes that detect displacement of the vibrating pair of Y-axis divisional detection weights, each of the X-axis weight connection springs being disposed in an X-axis, and each of the Y-axis weight connection springs being disposed in a Y-axis.

With this configuration, the drive weight and the detection weight are separated in terms of vibration by a pair of X-axis weight connection springs and a pair of Y-axis weight connection springs having an absorbing function for rotational vibration and a transmitting function for Coriolis force, and the detection weight includes a pair of X-axis divisional detection weights and a pair of Y-axis divisional detection weights which are independent from each other. Therefore, the detection weight vibrated by the Coriolis force does not suffer from an influence of the rotational vibration, and a pair of X-axis divisional detection weights and a pair of Y-axis divisional detection weights do not give an influence to each other when they are vibrated by the Coriolis force. In short, it is possible to detect angular velocity accurately, without influencing detection sensitivity of one divisional detection weight on detection sensitivity of the other divisional detection weight. Further, since the X-axis divisional detection weights and the Y-axis divisional detection weights are formed a pair which are different from each other and are supported by weight support springs respectively, it is possible to produce the gyro without detracting the detection sensitivity. Still further, by changing the number of detection electrodes, it is easily possible to produce a uniaxial angular velocity sensor (gyro) and a biaxial angular velocity sensor (gyro).

In this case, it is preferred that each of the X-axis weight support springs have a torsion bar spring extending in a Y-axis direction, and each of the Y-axis weight support springs have a torsion bar spring extending in an X-axis direction.

In the above rotational vibration type gyro, it is preferred that each of the X-axis weight support springs and each of the Y-axis weight support springs be formed of a flat spring which is thinner than the detection weight.

With this configuration, it is possible to appropriately vibrate each of the X-axis weight support springs and each of the Y-axis weight support springs independently from each other and is possible to form them smaller.

On the other hand, it is preferred that each of the X-axis divisional detection springs and each of the Y-axis divisional detection springs be formed in shape of a flat plate fan.

With this configuration, it is possible to enlarge areas of each of the X-axis divisional detection weights and each of the Y-axis divisional detection weights (an area of movable detection electrode) in over all (the drive weight) to a maximum extent, leading to enhancing the detection sensitivity.

Further, it is preferred that the anchor be disposed inside a pair of X-axis divisional detection weights and a pair of Y-axis divisional detection weights, each of the X-axis weight support springs be formed of a pair of torsion bar springs which extend from the anchor in the Y-axis direction, and each of the Y-axis weight support springs be formed of a pair of torsion bar springs which extend from the anchor in the X-axis direction.

With these configurations, it is possible to appropriately support the detection weights having a divided structure and the drive weight, and the detection weight having a divided structure does not suffer from any stress when it vibrates.

In the above rotational vibration type gyro, it is preferred that resonance frequency by rotational vibration of the drive weight be different from resonance frequency by vibration (detection direction) of each of the X-axis divisional detection weights and each of the Y-axis divisional detection weights.

With this configuration, though the sensitivity will be lowered, it is possible to restrain variation in detection sensitivity based on variation of manufacturing process.

Another rotational vibration type gyro of the present invention has: a drive weight in shape of a flat plate, a drive electrode that rotationally vibrates the drive weight around a Z-axis which passes through a center thereof, a detection weight that is disposed outside the drive weight to surround the drive weight and that has a pair of X-axis divisional detection weights in a flat plate fan shape vibrated with the drive weight by Coriolis force and a pair of Y-axis divisional detection weights in a flat plate fan shape vibrated independently from each of the X-axis divisional detection weights with the drive weight by the Coriolis force, an anchor that is projected outside the detection weight on a substrate and that supports the drive weight and the detection weight, a pair of X-axis weight support springs that are suspended between the anchor and each of the X-axis divisional detection weights and that function as hinge of each of the vibrating X-axis divisional detection weights, and a pair of Y-axis weight support springs that are suspended between the anchor and each of the Y-axis divisional detection weights and that function as hinge of each of the vibrating Y-axis divisional detection weights, a pair of X-axis weight connection springs that have an absorbing function for the rotational vibration and a transmitting function for the Coriolis force and that connect the drive weight and each of the X-axis divisional detection weights, and a pair of Y-axis weight connection springs that have an absorbing function for the rotational vibration and a transmitting function for the Coriolis force and that connect the drive weight and each of the Y-axis divisional detection weights, and a pair of X-axis detection electrodes that detect displacement of the vibrating pair of X-axis divisional detection weights and/or a pair of Y-axis detection electrodes that detect displacement of the vibrating pair of Y-axis divisional detection weights, each of the X-axis weight connection springs being disposed in an X-axis, and each of the Y-axis weight connection springs being disposed in a Y-axis.

With this configuration, the drive weight and the detection weight are separated in terms of vibration by a pair of X-axis weight connection springs and a pair of Y-axis weight connection springs having an absorbing function for rotational vibration and a transmitting function for Coriolis force, and the detection weight includes a pair of X-axis divisional detection weights and a pair of Y-axis divisional detection weights which are independent from each other. Therefore, the detection weight vibrated by the Coriolis force does not suffer from an influence of the rotational vibration, and a pair of X-axis divisional detection weights and a pair of Y-axis divisional detection weights do not give an influence to each other when they are vibrated by the Coriolis force. In short, it is possible to detect angular velocity accurately, without influencing detection sensitivity of one divisional detection weight on detection sensitivity of the other divisional detection weight. Further, since the X-axis divisional detection weights and the Y-axis divisional detection weights are formed a pair which are different from each other and are supported by weight support springs respectively, it is possible to produce the gyro without detracting the detection sensitivity. Still further, by changing the number of detection electrodes, it is easily possible to produce a uniaxial angular velocity sensor (gyro) and a biaxial angular velocity sensor (gyro).

As explained above, according to the present invention, since the detection weight is formed with a pair of X-axis divisional detection weights and a pair of Y-axis divisional detection weights which are independent from each other, detection sensitivity of one divisional detection weight does not influence on detection sensitivity of the other divisional detection weight. Therefore, it is possible to restrain so-called the other axis sensitivity and is possible to detect angular velocity with respect to each of the axis. Further, since the drive weight and the detection weight are separated in terms of vibration, it is possible to detect the angular velocity accurately because the detection weight is not influenced by the drive weight.

### BRIEF DESCRIPTION OF THE DRAWINGS

FIG. 1a shows a plan view of a rotational vibration type gyro according to the first embodiment.

FIG. 1b shows a cross sectional view of the rotational vibration type gyro according to the first embodiment.

FIG. 2a shows a plan view of a rotational vibration type gyro according to the first modification of the first embodiment.

FIG. 2b shows a cross sectional view of the rotational vibration type gyro according to the first modification of the first embodiment.

FIG. 3a shows a plan view of a rotational vibration type gyro according to the second modification of the first embodiment.

FIG. 3b shows a partial cross sectional view of the rotational vibration type gyro according to the second modification of the first embodiment.

FIG. 4 shows a plan view of a rotational vibration type gyro according to the second embodiment.

FIG. 5 shows a plan view of a rotational vibration type gyro according to a modification of the second embodiment.

### REFERENCE NUMERALS

1 rotational vibration type gyro
2 substrate
3 drive electrode
4 drive weight
5 detection weight
5A X-axis divisional detection weight
5B Y-axis divisional detection weight
6 anchor
7A X-axis weight support spring
7B Y-axis weight support spring
8A X-axis weight connection spring
8B Y-axis weight connection spring
9A X-axis detection electrode
9B Y-axis detection electrode

### BEST MODES FOR CARRYING OUT THE INVENTION

A rotational vibration type gyro according to one embodiment of the invention will be described in detail with reference to accompanying drawings hereinafter. The rotational vibration type gyro is a biaxial angular velocity sensor in a MEMS (micro electro mechanical system) sensor manufactured with material such as silicon by microfabrication technology, and is driven with forward reverse reciprocal rotational vibration in a plane surface. In the embodiment, the gyro is manufactured in a package having about 1 mm×1 mm dimensions. In figures, a left-right direction is defined as “X-axis direction”, a front-back direction is defined as “Y-axis direction”, and a perforation (penetration) direction is defined as “Z-axis direction”.

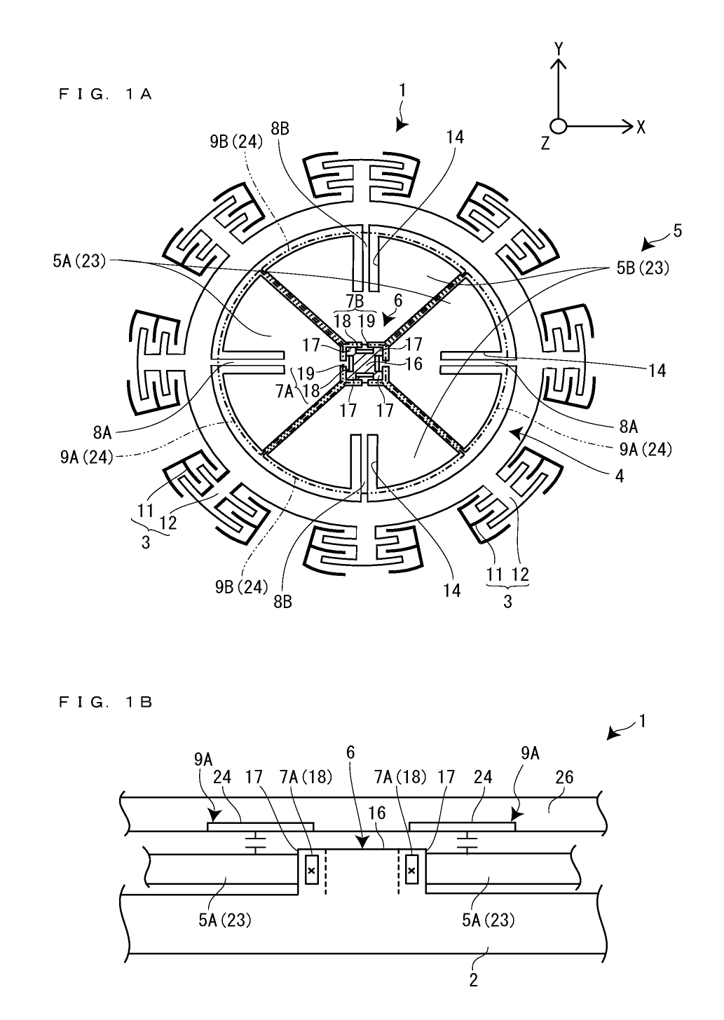

As shown in FIGS. 1a and 1b, a rotational vibration type gyro 1 includes: a plurality pairs of drive electrodes 3 (eight pairs in the embodiment) disposed at the outermost periphery on a substrate 2; a circular flat plate shaped drive weight 4 disposed inside the plurality pairs of the drive electrodes 3; a detection weight 5 disposed inside the drive weight 4 and having a pair of X-axis divisional detection weights 5A, 5A and a pair of Y-axis divisional detection weights 5B, 5B which are in shape of a flat plate fan; an approximately square-shaped anchor 6 disposed inside the detection weights 5; a pair of X-axis weight support springs 7A, 7A which are suspended between the anchor 6 and each of the X-axis divisional detection weights 5A, 5A; a pair of Y-axis weight support springs 7B, 7B which are suspended between the anchor 6 and each of the Y-axis divisional detection weights 5B, 5B; a pair of X-axis weight connection springs 8A, 8A which connect the drive weight 4 and each of the X-axis divisional detection weights 5A, 5A; a pair of Y-axis weight connection springs 8B, 8B which connect the drive weight 4 and each of the Y-axis divisional detection weights 5B, 5B; a pair of X-axis detection electrodes 9A, 9A which detect displacement of the vibrating pair of X-axis divisional detection weights 5A, 5A; and a pair of Y-axis detection electrodes 9B, 9B which detect displacement of the vibrating pair of Y-axis divisional detection weights 5B, 5B.

In this case, the drive weight 4 and the detection weights are made of conductive elements (same as support springs 7A, 7B and connection springs 8A, 8B), movable drive electrodes 12 described later are made of a portion of the drive weight 4, and movable detection electrodes 23 are made of a portion of the detection weight 5. Further, the connection configuration of the pair of X-axis weight support springs 7A, 7A, the pair of Y-axis weight support springs 7B, 7B, and the anchor 6 is made such that a movable portion mainly having the drive weight 4 and the detection weight 5 is symmetrical to the X-axis, the Y-axis and the Z-axis. In other words, the weighted center of the rotational vibration type gyro 1 (the movable portion) coincides with axial centers of the X-axis weight support springs 7A, 7A and the Y-axis weight support springs 7B, 7B and the anchor 6 in terms of the Z-axis. In terms of an X-plane and a Y-plane, the central position of the rotational vibration type gyro 1 (the movable portion) is disposed to coincide with the weighted center, thereby the rotational vibration type gyro 1 hardly suffers from an acceleration influence such as gravity and can be installed more freely.

The plurality of drive electrodes 3 are disposed circumferentially, for example, equally spaced apart one another. Each drive electrode 3 includes a fixed drive electrode 11 formed integrally on the substrate 2 and a movable drive electrode 12 provided to extend from the outermost end of the drive weight 4 in a radially outward direction as a portion of the drive weight 4. The fixed drive electrode 11 and the movable drive electrode 12 are facing to each other in shape of comb teeth. By applying an alternate voltage, the drive weight 4 vibrates rotationally around the Z-axis by electrostatic force generated between the electrodes 11 and 12.

The drive weight 4 is formed in shape of a flat circular plate centering on the Z-axis. The detection weight 5 includes the pair of X-axis divisional detection weights 5A, 5A and the pair of Y-axis divisional detection weights 5B, 5B which are in shape of a flat plate fan, each of outer circumferences thereof having a slight space to the drive weight 4 and formed in shape of a circular plate centering on the Z-axis which passes through an original point of X-Y axis coordinates as a whole. Further, the drive weight 4 and the detection weight 5 position on the same plane surface and have the same thickness. The pair of X-axis divisional detection weights 5A, 5A and the pair of Y-axis divisional detection weights 5B, 5B are formed of quite identical flat plate fans at an angle of 90 degrees and disposed at 90 degree pitch. When the rotational vibrating drive weight 4 receives an angular velocity around the X-axis, the drive weight 4 and the pair of X-axis divisional detection weights 5A, 5A vibrates around the pair of X-axis weight support springs 7A, 7A by the generated Coriolis force, respectively. In a similar manner, when the rotational vibrating drive weight 4 receives an angular velocity around the Y-axis, the drive weight 4 and the pair of Y-axis divisional detection weights 5B, 5B vibrates around the pair of Y-axis weight support springs 7B, 7B by the generated Coriolis force, respectively.

The pair of X-axis weight connection springs 8A, 8A are disposed to face to each other on the X-axis, and each of the X-axis weight connection springs 8A, 8A is disposed in a cutout portion 14 incised deeply in each of the X-axis divisional detection weights 5A, 5A. In a similar manner, the pair of Y-axis weight connection springs 8B, 8B are disposed to face to each other on the Y-axis, and each of the X-axis weight connection springs 8B, 8B is disposed in a slot cutout portion 14 incised deeply in each of the Y-axis divisional detection weights 5B, 5B. The pair of X-axis weight connection springs 8A, 8A and the pair of Y-axis weight connection springs 8B, 8B have a quite identical configuration, each of which has narrow width rectangle cross section, absorbs rotational vibration of the drive weight 4, and transmits the Coriolis force received by the drive weight 4. More specifically, the rotational vibration of the drive weight 4 is not transmitted to the detection weight 5 by the pair of X-axis weight connections springs 8A, 8A and the pair of Y-axis weight connection springs 8B, 8B, whereas the vibration by the Coriolis force can be transmitted to the detection weight 5. In this way, the pair of X-axis divisional detection weights 5A, 5A and the pair of Y-axis divisional detection weights 5B, 5B vibrate by the Coriolis force respectively, without suffering from the rotational vibration influence of the drive weight 4.

The anchor 6 is disposed at the center of the detection weight 5 and projects to be slightly higher than the detection weight 5 on the substrate 2. In this case, the anchor 6 has a square anchor body 16 and four anchor projected portions 17 which extend from the anchor body 16 in an diagonal direction outwardly. Each of the X-axis divisional detection weights 5A, 5A is supported by two pairs (four in total) of anchor projected portions 17 aligned in the Y-axis direction with the corresponding one of the X-axis weight support springs 7A, 7A, and each of the Y-axis divisional detection weights 5B, 5B is supported by two pairs (four in total) of anchor projected portions 17 aligned in the X-axis direction with the corresponding one of the Y-axis weight support springs 7B, 7B.

Each of the X-axis weight support springs 7A, 7A includes a torsion support spring 18 which is disposed to connect the anchor projected portions 17, 17 aligned in the Y-axis direction and extends in the Y-axis direction, and a connecting piece 19 which connects an intermediate portion of the torsion support spring 18 and a tip portion of one of the X-axis divisional detection weights 5A, 5A. As a similar manner, each of the Y-axis weight support springs 7B, 7B includes a torsion support spring 18 which is disposed to connect the anchor projected portions 17, 17 aligned in the X-axis direction and extends in the X-axis direction, and a connecting piece 19 which connects an intermediate portion of the torsion support spring 18 and a tip portion of one of the Y-axis divisional detection weights 5B, 5B. Each torsion support springs 18 is formed to have narrow width rectangular cross-section as the above each of the connection springs 8A, 8B, supports the detection weight 5 and the drive weight 4 in a suspended state from the substrate 2, and functions as hinge shaft of the detection weight 5 vibrated by the Coriolis force. Thus, each torsion support spring 18 functions as torsion spring. In this way, each of the X-axis divisional detection weights 5A, 5A received the Coriolis force vibrates around the torsion support spring (Y-axis) 18 which supports one of the X-axis divisional detection weights 5A, 5A, and each of the Y-axis divisional detection weights 5B, 5B received the Coriolis force vibrates around the torsion support spring (X-axis) 18 which supports one of the Y-axis divisional detection weights 5B, 5B.

The pair of X-axis detection electrodes 9A, 9A includes the pair of movable detection electrodes 23, 23 formed with the pair of X-axis divisional detection weights 5A, and a fan-shaped pair of fixed detection electrodes 24, 24 which have narrow space to the pair of movable detection electrodes 23, 23 (the space is larger than vibration amplitude of the detection weight 5) and which face thereto. In a similar manner, the pair of Y-axis detection electrodes 9B, 9B includes the pair of movable detection electrodes 23, 23 formed with the pair of Y-axis divisional detection weights 5B, 5B, and a fan-shaped pair of fixed detection electrodes 24, 24 which have narrow space to the pair of movable detection electrodes 23, 23 and which face thereto. Each of the fixed detection electrodes 24 may be provided on the substrate 2 and may be provided in the inner surface of a seal member 26 as described in the figure. When the X-axis divisional detection weights 5A, 5A or the Y-axis divisional detection weights 5B, 5B vibrate by the Coriolis force, respective electrostatic capacitances between the movable detection electrodes 23 and the fixed detection electrodes 24 change and desired angular velocity is detected based on the change.

In such a rotational vibration type gyro 1, it is possible to enhance detection sensitivity by setting resonance frequency by rotational vibration of the drive weight 4 and resonance frequency by vibration in a detection direction of the detection weight 5 in equal, but it is extremely difficult to set the above resonance frequencies equally in an actual manufacturing process. In the embodiment, the resonance frequency by the rotational vibration of the drive weight 4 and the resonance frequencies by vibration of each of X-axis divisional detection weights 5A, 5A and each of the Y-axis detection weights 5B, 5B are differentiated on purpose, thereby, though the sensitivity will be lowered, it is possible to limit variation in detection sensitivity based on variation of a manufacturing process and is possible to improve yield ratio of products. Especially, it comes in very useful for the detection weight 5 in a divided shape as the embodiment.

As the embodiment, in a case that the pair of fixed detection electrodes 24, 24 are provided in the X-axis direction and the Y-axis direction, the biaxial rotational vibration type gyro 1 in the X-axis direction and the Y-axis direction is produced, whereas in a case that the pair of fixed detection electrodes 24, 24 is provided in the X-axis direction or the Y-axis direction, a uniaxial rotational vibration type gyro is formed. In other words, it is easily possible to produce uniaxial gyros and biaxial gyros on request basis.

As described above, according to the present embodiment, since the detection weight 5 includes the pair of X-axis divisional detection weights 5A, 5A and the pair of Y-axis divisional detection weights 5B, 5B which are independent from each other, the pair of X-axis divisional detection weights 5A, 5A and the pair of Y-axis divisional detection weights 5B, 5B do not give a mutual influence when they are vibrated by the Coriolis force. In other words, it is possible to accurately detect the angular velocity, without influencing the detection sensitivity of one detection weight 5 on the detection sensitivity of the other detection weight 5. Further, since the X-axis divisional detection weights 5A, 5A and the Y-axis divisional detection weights 5B, 5B include a pair of weights which are independent from each other and are supported by the support springs 7A, 7A, 7B, 7B respectively, it is easily possible to form such a structure without impairing their detection sensitivity. Still further, since the rotational vibration generated by the drive weight 4 is absorbed by each of the connection springs 8A, 8B, the detection weight 5 does not incur noise by the rotational vibration and it is possible to detect the angular velocities around the X-axis and the Y-axis accurately.

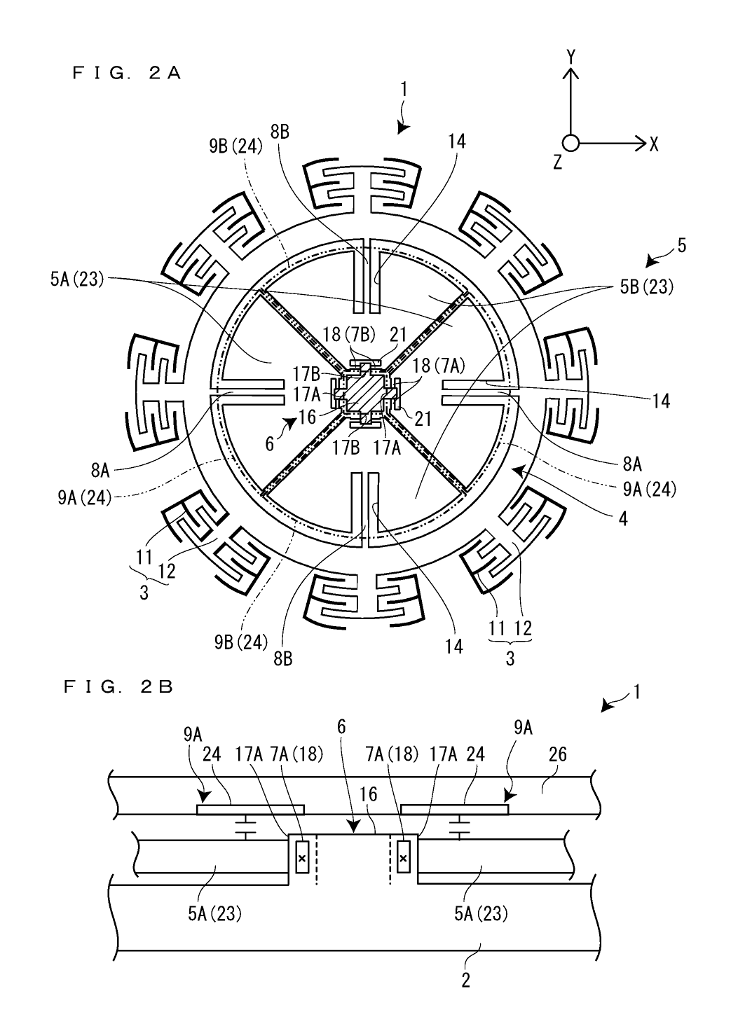

Referring to FIG. 2, the first modification of the above first embodiment will be explained. In modifications and other embodiments, portions different from those in the first embodiment will be mainly described. In this modification, the anchor 6, the X-axis weight support springs 7A, 7A and the Y-axis weight support springs 7B, 7B are different from those of the first embodiment.

In this case, the anchor 6 is disposed at the center of the detection weight 5 and projects to be slightly higher than the detection weight 5 on the substrate 2. The anchor 6 also has the square anchor body 16, the pair of anchor projected portions 17A, 17A which extend from the anchor body in an outer direction of the X-axis and the pair of anchor projected portions 17B, 17B which extend from the anchor body 16 in an outer direction of the Y-axis. Each of the X-axis divisional detection weights 5A, 5A is supported by each of the X-axis anchor projected portions 17A, 17A with one of the corresponding X-axis weight support springs 7A, 7A and each of the Y-axis divisional detection weights 5B, 5B is supported by each of the Y-axis anchor projected portions 17B, 17B with one of the corresponding Y-axis weight support springs 7B, 7B.

Each of the X-axis weight support springs 7A, 7A has the pair of torsion support springs 18, 18 extending from both side surfaces of each of the X-axis anchor projected portions 17A, 17A in the Y-axis direction respectively and is connected to both side surfaces of a “U” shaped cutout portion 21 formed at the inner periphery side of each of the X-axis divisional detection weights 5A, 5A. Likewise, each of the Y-axis weight support springs 7B, 7B has the pair of torsion support springs 18, 18 extending from both side surfaces of each of the Y-axis anchor projected portions 17B, 17B in the X-axis direction respectively and is connected to both side surfaces of a “U” shaped cutout portion 21 formed at the inner periphery side of each of the Y-axis divisional detection weights 5B, 5B. Further, each of the torsion support springs 18, 18 is formed to have narrow width rectangular cross-section as the above each of the connection springs 8A, 8B, supports the detection weight 5 and the drive weight 4 in a suspended state from the substrate 2, and functions as hinge shaft of the detection weight 5 vibrated by the Coriolis force. In short, each of the torsion support springs 18, 18 functions as torsion spring. In this way, each of the X-axis divisional detection weights 5A, 5A received the Coriolis force vibrates around the pair of torsion support springs (Y-axis) 18, 18 which support the X-axis divisional detection weights 5A, 5A, and each of the Y-axis divisional detection weights 5B, 5B vibrates around the pair of torsion support springs (X-axis) 18, 18 which support the Y-axis divisional detection weights 5B, 5B.

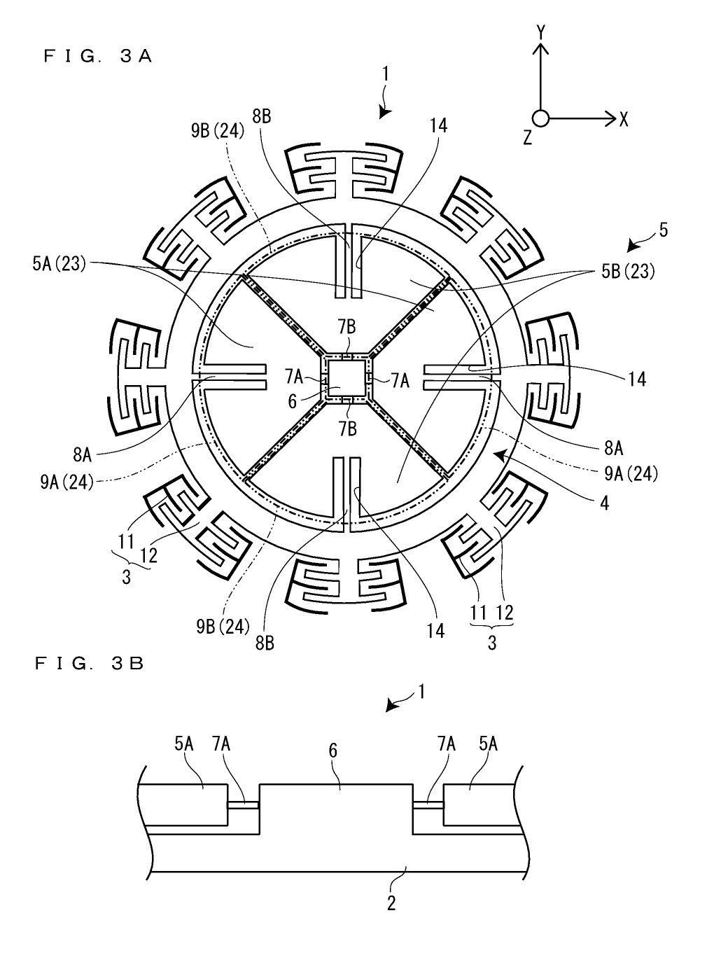

Referring to FIG. 3, the second modification of the above first embodiment will be explained. In the second modification, each of the X-axis weight support springs 7A, 7A and each of the Y-axis weight support springs 7B, 7B are flat springs extending from the anchor 6 in a cross shape. In this case, the anchor 6 is formed in a square shape on the Z-axis, and the inner edge side of each of the X-axis divisional detection weights 7A, 7A and the inner edge side of each of the Y-axis divisional detection weights 7B, 7B are formed in parallel with the corresponding sides of the anchor 6. Each of the X-axis weight support springs 7A, 7A having the flat spring is formed enough thinner than each of the X-axis divisional detection weights 5A, 5A and is connected to an intermediate position in a thickness direction of each of the X-axis divisional detection weights 5A, 5A. Likewise, each of the Y-axis weight support springs 7B, 7B is formed enough thinner than each of the Y-axis divisional detection weights 5B, 5B and is connected to an intermediate position in a thickness direction of each of the Y-axis divisional detection weights 5B, 5B.

By such a structure, it is possible to reduce the sizes of the X-axis weight support springs 7A, 7A and the Y-axis weight support springs 7B, 7B and is possible to make the X-axis divisional detection weights 5A, 5A and the Y-axis divisional detection weights 5B, 5B larger. It is preferable that each of the X-axis weight support springs 7A, 7A and each of the Y-axis weight support springs 7B, 7B be formed as thinner as and as wider as possible.

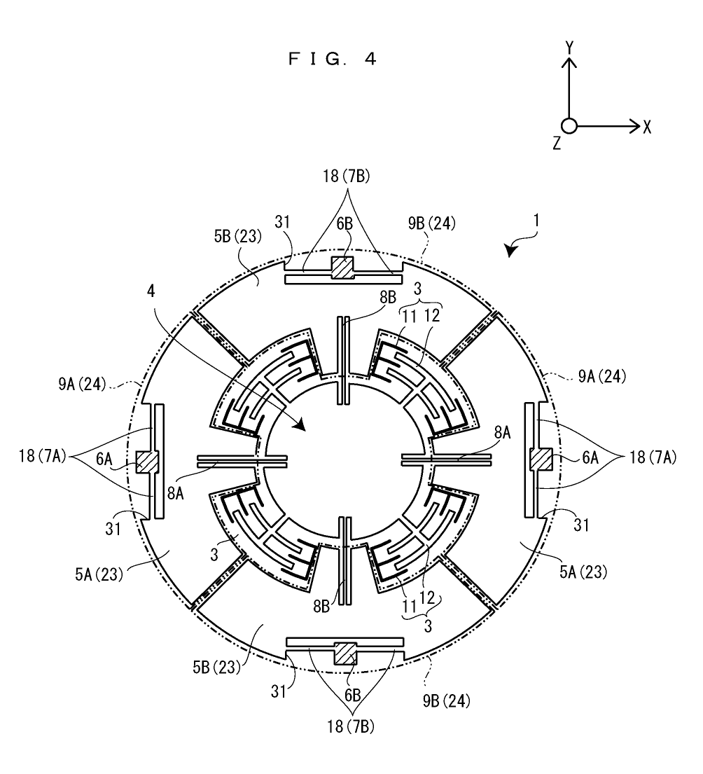

Referring to FIG. 4, the rotational vibration type gyro 1 according to the second embodiment of the present invention will be explained. The second embodiment differs from the rotational vibration type gyro 1 in the first embodiment in that the detection weight 5 is disposed at an outer side and the drive weight 4 is disposed at an inner side. With this configuration, the pair of X-axis weight support springs 7A, 7A and the pair of Y-axis weight support springs 7B, 7B are disposed at an outer side of the detection weight 5.

In other words, the rotational vibration type gyro 1 includes: the detection weight 5 positioned on an outer periphery and forming a circular flat plate shape in overall on the substrate 2 and having the pair of X-axis divisional detection weights 5A, 5A and the pair of Y-axis divisional detection weights 5B, 5B which are in shape of a flat plate fan; the approximately circular flat plate shaped drive weight 4 disposed inside the detection weight 5; the four drive electrodes 3 disposed at an outer side of the drive weight 4 at 45 degrees with respect to the X-axis direction and the Y-axis direction; a pair of X-axis anchors 6A, 6A facing wide cutout portions 31 formed at an outer edge of each of the X-axis divisional detection weights 5A, 5A; a pair of Y-axis anchors 6B, 6B facing wide cutout portions 31 formed at an outer edge of each of the Y-axis divisional detection weights 5B, 5B; the pair of X-axis weight support springs 7A, 7A suspended between each of the X-axis anchors 6A, 6A and each of the X-axis divisional detection weights 5A, 5A; the pair of Y-axis weight support springs 7B, 7B suspended between each of the Y-axis anchors 6B, 6B and each of the Y-axis divisional weights 5B, 5B; the pair of X-axis connection springs 8A, 8A connecting the drive weight 4 and each of the X-axis divisional detection weights 5A, 5A; the pair of Y-axis connection springs 8B, 8B connecting the drive weight 4 and each of the Y-axis divisional detection weights 5B, 5B; the pair of X-axis detection electrodes 9A, 9A which detect displacement of the vibrating pair of X-axis divisional detection weights 5A, 5A; and the pair of Y-axis detection electrodes 9B, 9B which detect displacement of the vibrating pair of Y-axis divisional detection weights 5B, 5B.

Also, in this case, the pair of X-axis divisional detection weights 5A, 5A and the pair of Y-axis divisional detection weights 5B, 5B are formed in a quite identical configuration. Further, each of the X-axis weight support springs 7A, 7A includes the pair of torsion support springs (torsion springs) 18, 18 extending from both side surfaces of each of the X-axis anchors 6A, 6A in the Y-axis direction and connected to both side surfaces of the wide cutout portions 31 of each of the X-axis divisional detection weights 5A, 5A. Likewise, each of the Y-axis weight support springs 7B, 7B includes a pair of torsion support springs 18, 18 extending from both side surfaces of each of the Y-axis anchors 6B, 6B in the X-axis direction and connected to both side surfaces of the wide cutout portions 31 of each of the Y-axis divisional detection weights 5B, 5B.

In this embodiment, since the detection weight 5 includes the pair of X-axis divisional detection weights 5A, 5A and the pair of Y-axis divisional detection weights 5B, 5B, which are independent from each other, it is possible to detect the angular velocities around the X-axis and the Y-axis accurately, without influencing the detection sensitivity of the X-axis divisional detection weights 5A, 5A on the detection sensitivity of the Y-axis divisional detection weights 5B, 5B.

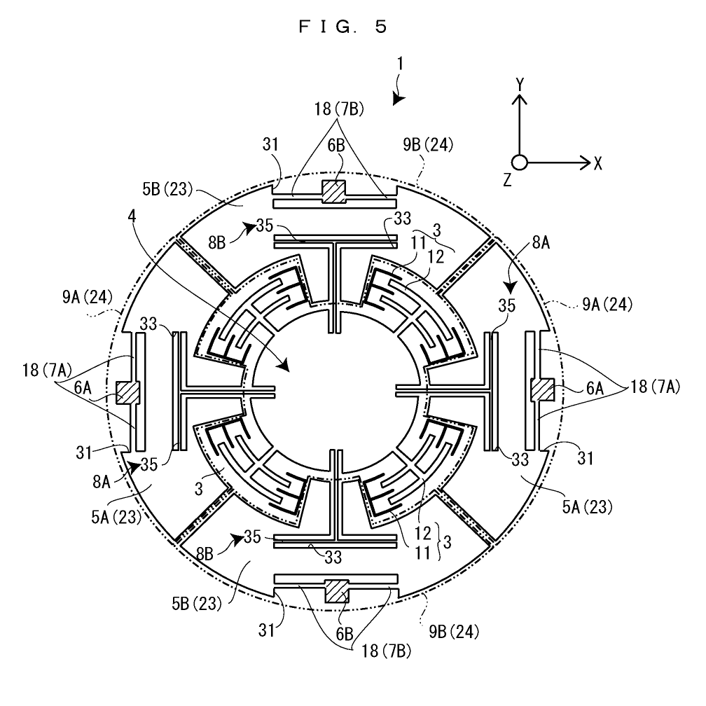

Referring to FIG. 5, a modification of the second embodiment will be explained. In this modification, each of the X-axis weight connection springs 8A, 8A is formed in shape of “T” and is disposed in a “T” shaped cutout portion 33 formed in each of the X-axis divisional weights 5A, 5A. A straight portion 35 of each of the X-axis weight connection springs 8A, 8A on the X-axis divisional detection weights 5A, 5A side is disposed in parallel with the X-axis weight support springs 7A, 7A and functions as torsion spring for the X-axis divisional detection weights 5A, 5A. Likewise, a straight portion 35 of each of the Y-axis weight connection springs 8B, 8B on the Y-axis divisional detection weights 5B, 5B side is disposed in parallel with the Y-axis weight support springs 7B, 7B and functions as torsion spring for the Y-axis divisional detection weights 5B, 5B.

By having this configuration, each of the X-axis divisional detection weights 5A, 5A and Y-axis divisional detection weights 5B, 5B vibrated by the Coriolis force is supported with enough flexibility in the vibration direction and the vibration is not restrained by the X-axis weight connection springs 8A, 8A and the Y-axis weight connection springs 8B, 8B. Therefore, it is possible to detect the angular velocities around the X-axis and the Y-axis without lowering the detection sensitivity.

1-7. (canceled)

8. A rotational vibration type gyro comprising:
a drive weight in shape of a circular flat plate;
a drive electrode that rotationally vibrates the drive weight around a Z-axis which passes through a center thereof;
a detection weight that is disposed inside the drive weight and that has a pair of X-axis divisional detection weights in a flat plate shape vibrated with the drive weight by Coriolis force generated at the drive weight and a pair of Y-axis divisional detection weights in a flat plate shape vibrated independently from each of the X-axis divisional detection weights with the drive weight by the Coriolis force generated at the drive weight;
an anchor that is projected inside the detection weight on a substrate and that supports the drive weight through the detection weight;
a pair of X-axis weight support springs that are suspended between the anchor and each of the X-axis divisional detection weights and that function as hinge of each of the vibrating X-axis divisional detection weights, and a pair of Y-axis weight support springs that are suspended between the anchor and each of the Y-axis divisional detection weights and that function as hinge of each of the vibrating Y-axis divisional detection weights;
a pair of X-axis weight connection springs that have an absorbing function for the rotational vibration and a transmitting function for the Coriolis force and that connect the drive weight and each of the X-axis divisional detection weights, and a pair of Y-axis weight connection springs that have an absorbing function for the rotational vibration and a transmitting function for the Coriolis force and that connect the drive weight and each of the Y-axis divisional detection weights; and
a pair of X-axis detection electrodes that detect displacement of the vibrating pair of X-axis divisional detection weights and/or a pair of Y-axis detection electrodes that detect displacement of the vibrating pair of Y-axis divisional detection weights;
each of the X-axis weight connection springs being disposed in an X-axis, and each of the Y-axis weight connection springs being disposed in a Y-axis.

9. The rotational vibration type gyro according to claim 8, wherein each of the X-axis weight support springs has a torsion bar spring extending in a Y-axis direction, and each of the Y-axis weight support springs has a torsion bar spring extending in an X-axis direction.

10. The rotational vibration type gyro according to claim 8, wherein each of the X-axis weight support springs and each of the Y-axis weight support springs is formed of a flat spring which is thinner than the detection weight.

11. The rotational vibration type gyro according to claim 9, wherein each of the X-axis divisional detection weights and each of the Y-axis divisional detection weights is formed in shape of a flat plate fan.

12. The rotational vibration type gyro according to claim 9, wherein the anchor is disposed inside the pair of X-axis divisional detection weights and the pair of Y-axis divisional detection weights, each of the X-axis weight support springs is formed of a pair of torsion bar springs which extend from the anchor in the Y-axis direction, and each of the Y-axis weight support springs is formed of a pair of torsion bar springs which extend from the anchor in the X-axis direction.

13. The rotational vibration type gyro according to claim 9, wherein resonance frequency by rotational vibration of the drive weight is different from resonance frequency by vibration of each of the X-axis divisional detection weights and each of the Y-axis divisional detection weights.

14. A rotational vibration type gyro comprising:
a drive weight in shape of a flat plate;
a drive electrode that rotationally vibrates the drive weight around a Z-axis which passes through a center thereof;
a detection weight that is disposed outside the drive weight to surround the drive weight and that has a pair of X-axis divisional detection weights in a flat plate fan shape vibrated with the drive weight by Coriolis force generated at the drive weight and a pair of Y-axis divisional detection weights in a flat plate fan shape vibrated independently from each of the X-axis divisional detection weights with the drive weight by the Coriolis force generated at the drive weight;
an anchor that is projected outside the detection weight on a substrate, that supports the detection weight and that supports the drive weight through the detection weight;
a pair of X-axis weight support springs that are suspended between the anchor and each of the X-axis divisional detection weights and that function as hinge of each of the vibrating X-axis divisional detection weights, and a pair of Y-axis weight support springs that are suspended between the anchor and each of the Y-axis divisional detection weights and that function as hinge of each of the vibrating Y-axis divisional detection weights;
a pair of X-axis weight connection springs that have an absorbing function for the rotational vibration and a transmitting function for the Coriolis force and that connect the drive weight and each of the X-axis divisional detection weights, and a pair of Y-axis weight connection springs that have an absorbing function for the rotational vibration and a transmitting function for the Coriolis force and that connect the drive weight and each of the Y-axis divisional detection weights; and
a pair of X-axis detection electrodes that detect displacement of the vibrating pair of X-axis divisional detection weights and/or a pair of Y-axis detection electrodes that detect displacement of the vibrating pair of Y-axis divisional detection weights;
each of the X-axis weight connection springs being disposed in an X-axis, and each of the Y-axis weight connection springs being disposed in a Y-axis.

15. The rotational vibration type gyro according to claim 10, wherein each of the X-axis divisional detection weights and each of the Y-axis divisional detection weights is formed in shape of a flat plate fan.

16. The rotational vibration type gyro according to claim 10, wherein resonance frequency by rotational vibration of the drive weight is different from resonance frequency by vibration of each of the X-axis divisional detection weights and each of the Y-axis divisional detection weights.
